(19) United States
(12) Patent Application Publication
(10) Pub. No.: US 2008/0096002 A1
(43) Pub. Date: Apr. 24, 2008

(54) Coated Paper Product and Method and Apparatus for Manufacturing Thereof

(76) Inventors: Markku Leskela, Muijala (FI); Stina Nygard, Lohja (FI); Juha Koponen, Lohja (FI)

Correspondence Address: COHEN, PONTANI, LIEBERMAN & PAVANE, 551 FIFTH AVENUE, SUITE 1210, NEW YORK, NY, 10176, US

(21) Appl. No.: 11/794,438

(22) PCT Filed: Dec. 30, 2005
(86) PCT No.: PCT/FI05/00563

§ 371 Date: Aug. 20, 2007

(30) Foreign Application Priority Data
Dec. 31, 2004 (FI) 20041707

(51) Int. Cl. B32B 5/02; B05C 5/00; B05D 1/30

(52) U.S. Cl. 428/311.11; 118/325; 427/420

(57) ABSTRACT

Coated paper product and method and apparatus for the production thereof. The paper product comprises a base paper, the porosity of which is at least 300 ml/min (Bentsen) and at least one side of which is coated with a pigment-bearing coating layer. The coating layer according to the present invention comprises a homogeneous film, which is formed of binder and pigments and which is brought onto the surface of the base paper using curtain coating so that the variation of the grammage of the layer is less than 5%, and so that the coating layer is not penetrated into the base paper, in which case the coating layer covers at least 95% of the surface of the base paper. By means of the present invention such a good coverage is achieved that the porosity of the base paper does not affect the gloss or smoothness of the coated paper, nor how the paper functions as a printing base.

The present invention relates to a coated paper product in accordance with the preamble of Claim 1.

A product such as this usually comprises a base paper, the porosity of which is at least 300 ml/min (Bentsen), and at least one surface of which is coated with a pigment-bearing coating layer.

The present invention also relates to a method of manufacturing a coated paper product, according to the preamble of Claim 5 and an apparatus, according to the preamble of Claim 13.

Essential in papermaking, as in other bulk product processes, is continuous lowering of costs. There are two effective ways to cut the fixed costs; to increase the papermaking production line width or, correspondingly, to increase the speed. Increasing the speed is especially important for thin paper qualities. Here, thin paper qualities mean end products having a grammage of less than 90 g/m². In that case the grammage of the base web is approximately 20-60 g/m² and the coat weights are typically 2-15 g/m² on each side.

Manufacturing and coating of the base paper are the most essential sub-processes with regard to the fixed costs, i.e. when the capital involved in the machinery and the staff expenses are considered. When the speed is increased with apparatuses nowadays in general use, several problems will be encountered. Particularly problematic in regard to the quality of the end product and the use of the coating machine in manufacturing of base paper is that when the speed is increased, the difference in draw between the forward end of the drying section and the wet press must be increased in order to maintain the control of the wet web. Stretching of the wet web results in the structure of the base paper opening up and pores are generated in it, through which pores the coating paste, which is applied onto the surface of the base paper at the coating machine, is forced into the base paper so that, in the worst case, the paste totally penetrates the paper. Such opening up of the pores always occurs to some extent but the problem becomes considerably worse when the difference in draw, mentioned above, increases, and to ensure the control of the web this difference in draw must be increased if the speed of the paper machine is increased. Increased porosity of the base web is also especially harmful at high speeds because nowadays film sizing offers the best possibilities for high coating speeds. In this technique the paste is transferred onto the so-called applying cylinder and the web to be coated is lead to the roll nip where the paste is transferred onto the base paper through a controlled splitting of the coating layer. However, in the nip a considerable pressure pulse is concentrated on the paper and the paste. As a result, the paste can even penetrate through the base paper, if the porosity of the paper is too high.

With regard to the film sizing at high speeds, new problems are encountered because the paste has to be diluted with water when the speed increases, in order to adapt the runability rheology of the paste to match the coating speed. If the paste is diluted too much, fuming occurs in the film sizing and the quality of the paper to be coated will eventually be destroyed. In addition, when diluting the paste its viscosity decreases and it penetrates even more easily into the base paper.

To eliminate the problems mentioned above, it is useful, in the film coating, to maximize the dry solids of the paste and to use as small metering rods as possible with high speeds of rotation. In that case, it is possible to utilise a speed range of 1500-2000 m/min.

However, in practice in the film coating the thickness of the film fed in the nip is bigger than optimal and the film cannot split into two pieces anymore but instead it breaks into three pieces. Initially the middle part of the film is visible as fume. If the speed is increased further or the paste is diluted (the paste film gets thicker), the paste will spray out from the middle of the nip.

Today, even speeds >1800 m/min can be achieved in blade coating, too. However, the blade pressure increases with increasing speed and, as a result, controlling of the coat weight is difficult and blade beard is formed more easily. Diluting of the paste and/or increasing the water retention are used as controlling variables. High speed, low dry solids and low coat weight at the blade stations are runability risks and they may result in web breaks.

The purpose of the present invention is to eliminate the disadvantages associated with the known technology and to generate a completely new solution for the production of coated paper products.

In particular, the purpose of the present invention is to generate a process and an apparatus for coating porous paper qualities at high speeds. The present invention also relates to a solution which can be used for coating paper and cardboard webs effectively by using coating speeds of at least 2000 m/min.

The present invention is based on the idea that a coating layer is brought onto a porous paper web, which said layer comprises a homogeneous film formed of binder and pigments, and which is brought onto the base paper surface in a non-contact manner, in other words by bringing the coating layer onto the web from the coater, the nozzle (or generally speaking “applying/spreading element”) of which does not touch the web. Most suitably curtain coating is used as such a coating method.

In curtain coating the film which is brought onto the web is thin and of uniform thickness. The film thickness is usually approximately 1-100 micrometers and the variation in the grammage of the layer is kept quite low, most suitably the variation is <±10%, especially <±5%, through the width of the film. By applying the coating layer as a homogeneous film, in a non-contact manner, onto the surface of the paper web, penetration of the coating layer into the base paper can be prevented and, at the same time, a quite good coverage can be achieved—generally the coating layer covers at least 95%, especially at least 97%, and most suitably at least 98% of the surface of the base paper. Here “coverage” means that the film from the applying/spreading element is brought onto the surface of the base paper in such a way that at least 95% (or at least 97% or, correspondingly, at least 98%) of the base paper is overlayed by at least one film layer, at least on one side of the paper web.

According to the present invention, a curtain coater can be used at a coating speed which is very high, preferably at least approximately 2000 m/min. Typically, the speed is approximately 2000-2800 m/min in the range of operation. As a result, a unique solution comes up, in which one coater is used on-line or off-line to coat the paper web which has been generated by using a production speed which is 2000 m/min or higher. According to the present invention, here “production speed” means the webbing speed of one single paper machine or the combined webbing speeds of two or more paper machines. In the first case the coating can be carried out on-line or off-line, in the latter case at least part of the coating is carried out off-line. On-line coating means coating which is carried out in association with the paper machine without an intermediate rolling of the paper, and off-line coating means, correspondingly, that the paper is reel-fed after the paper machine before the coating. In the present invention, the coating speed of the curtain coater is chosen so that it is at least 10%, preferably at least 20% higher than the said production speed. When paper webs from several paper machines are coated using one single curtain coater, the porosity of the webs can be 200 ml/min (Bentsen) or higher.

More specifically, the paper product according to the present invention is characterized by what is stated in the characterizing part of Claim 1.

The method according to the invention is, again, characterized by what is stated in the characterizing part of Claim 5.

The apparatus according to the invention is characterized by what is stated in the characterizing part of Claim 13.

Considerable advantages are obtained by means of the invention. Thus, by acting according to the present invention it is possible to considerably increase particularly the speed of the paper production line without decreasing the quality of the manufactured paper product. By choosing the said curtain coating as the coating method, in accordance with the present invention, it is possible to run very high coating speeds and, in addition, implementation of this method solves the above problem which emerged at high speeds from the increased porosity. In the invention the paste does not have to be diluted with increasing speed. Besides, when implementing the invention the porosity of the base paper is no longer of conclusive significance for the paper quality when a very high speed is used. Especially the test results presented below show that when curtain coating is used such a good coverage is achieved that the porosity of the base paper does not affect the gloss or the smoothness of the coated paper, nor does it affect how good the paper is as a printing base.

With regard to the properties, it is essential that the coating film covers at least 95%, especially at least 98%, of the surface of the paper. We have discovered that when printing, the covering power correlates with the smoothness of the print quality and the quality of the halftone dots. In other words, when the order of the coverage is as indicated above, there is no spottiness or the spottiness is at maximum so small that it does not affect the appearance of the paper product. Also, the better the coverage of the coating is, the smaller the spreading of dots/the amount of missing dots is.

In the following, the present invention will be examined more closely with the aid of a detailed description and some working embodiments.

In the present invention, a “porous” paper means a paper, the porosity of which is at least 300 ml/min (Bentsen), especially at least 310 ml/min (Bentsen), and in general even at least 340 ml/min (Bentsen). Normal porosity range of paper is approximately 300-600 ml/min.

A “thin” coating layer, the grammage of which is at maximum 20 g/m²/paper side, typically at maximum approximately 15 g/m², especially at maximum approximately 12 g/m²/paper side, is applied onto a porous paper. The minimum thickness of the coating layer is determined by which is the lowest thickness limit that still gives a homogeneous, unbroken film from the nozzle. Generally, approximately 1 g/m², especially approximately 2 g/m² can be set as the low limit.

The grammage of the base paper, (i.e. uncoated paper web) is generally 15-150 g/m², typically 20-100 g/m², especially approximately 25-90 g/m² and most suitably approximately 20-60 g/m².

Consequently, the grammage of the paper to be produced is generally in the range of approximately 20-160 g/m², although the present invention is more preferably used for the production of thin paper qualities (approximately 20-70 g/m²) which are specified above, in the introduction.

The present invention can be used for instance for producing different thin printing papers, such as LWC papers or offset papers.

In the method of producing a coated paper product, according to the present invention, the way of operation is usually as follows:

First, a base paper web with a porosity of at least 300 ml/min (Bentsen) is formed at the paper machine. The paper web is formed in a way which is known per se by slushing the paper pulp to an adequate thickness (typically solids content of approximately 0.1-1%) and spreading it on the wire. Filler is added to the fibre slush most suitably in the headbox of the paper or cardboard machine. The added quantity is generally approximately 1-50 weight-% of the weight of the pulp fibres. Besides filler, additives such as retention chemicals and anti-foaming agents are often added to the fibre slush.

At the paper machine the fibre slush is usually webbed to a single layer using a conventional technique, but it is also possible to produce a multilayer product. Multiple webbing technique can be applied for the production of these products. Suitable pulp feeding arrangements are described for instance in the Finnish Patent Application 105 118 and EP Published Patent Application 824 157.

After that, at least one side of the base paper web coming from the paper machine is coated with a pigment bearing coating composition. For the coating a curtain coater is used with a coating speed of at least 2000 m/min, most suitably at least 2100 m/min or higher, preferably even 2500 m/min or higher.

Most suitably, in this case a coating composition is spread on the surface of the paper web. The viscosity of the composition is adequate to generate a homogeneous and self-supporting film, the front edge of which is fastened to the moving web and thus pulls along the film from the coater. The width of the applying apparatus/nozzle is most suitably at least as big as the width of the paper web to be coated, to allow the intended 95% (or bigger) coverage. It is even possible to act in such a way that the paper web is coated with a coating film, the edges of which slightly exceed the edges of the paper web.

As mentioned above, using curtain coating a coating layer with a grammage of approximately 2-30 g/m²/paper side is formed on the surface of the paper web.

According to the present invention, the minimum volumetric flow rate/width must be over 1.0 cm²/s, especially at least 1.5 cm²/s, at maximum approximately 10 cm²/s, to allow the curtain to be stable and to have a desired thickness. The dynamic surface tension must be approximately 20-60 mN/m, especially approximately 35-55 mN/m, typically less than approximately 40 mN/m.

The coating takes places in a non-contact manner, in which case the coating curtain is brought to the paper web from above it. Typically, a gap of approximately 1-1000 mm is left between the nozzle of the curtain coater and the paper web, most suitably the gap is approximately 1-500 mm, especially approximately 10-500 mm or even 100-500 mm. The height depends on the coat weight and the coating speed. At the nozzle the thickness of the film is generally approximately 0.1-10 mm, especially approximately 1-5 mm, in the case of free fall the film becomes thinner, below 100 microns. The thickness of the sheet pack is approximately 1-50, especially approximately 2-30, typically approximately 5 microns.

The film comprises a homogeneous film which is of quite uniform thickness and which is formed of the binder and the pigments. At the surface of the paper the variation of the grammage of the film is smaller than 5%, especially smaller than approximately 3%, typically approximately 0.1-2.5%. In order to determine the variation, the grammage can be determined from individual small, for instance approximately 1-100 mm² measurement points. The values determined from these are compared to the average grammage of the layer. The measurement points are most suitably chosen equidistantly through the whole width of the curtain.

Curtain coating is a coating technique which is known per se and which has been used for coating of different products, even chocolate candies and similar objects of irregular shape. Applications in which the method was used to coat moving webs, such as aluminium foils and corrugated board, became common in the 1960's because curtain coating made it possible to use considerably higher speeds than earlier. One of the latest development steps of curtain coating is multiple curtain coating, which has been developed in the photographic paper industry.

When it was found out how to carry out de-aeration of the coating more efficiently, it became possible to use curtain coating at the speed levels of paper machines, too.

Nowadays curtain coating is used for production of, among other things, photographic, inkjet and special papers as well as packages. Possible applications in the future are, among others, functional coatings of paper and package products. Using laboratory apparatus it has been possible to coat simultaneously at maximum even 25 layers.

There are three different types of curtain coating apparatuses: slot, slide and curtain type solutions. The general operation principle for all three is that all the coating material which is fed to the coating unit is transferred to the surface to be coated. Thus the average thickness of the wet film is determined by the input flow speed, the width of the coating unit and the speed of the substrate to be coated, and it is independent of the rheological properties of the coating. All three methods are suitable for multiple layer coating, too. The most important differences between these methods are the free flow distance of the moving substrate and the coating, the direction of the flow in relation to gravitational force and the force induced to the substrate by the flowing coating.

Typically, in slot and slide coatings the free fall distance is short or non-existent. Consequently, the main interest in the paper industry has been focused on the curtain coating because in this method the applying of the coating layer is carried out by using a fairly long (˜50-30 cm) free fall. The two best properties of the curtain coating are the ability to coat, if desired, uneven surfaces with extremely thin uniform layers, and the possibility to use high speeds. Since the coating takes place without contact with the substrate, the method tolerates interferences quite well.

When operated according to the present invention, the coating layer cannot penetrate into the base paper in association with the coating. In practice, this usually means that at maximum approximately 10 weight-%, most suitably less than 5 weight-%, especially less than 3 weight-% and especially less than approximately 1 weight-% of the coating penetrates underneath the surface layer of the web. The thickness of the “surface layer” of the web is typically at maximum 20%, especially at maximum 10%, most suitably at maximum 5% of the total thickness of the web. The total thickness of the web to be coated is, in turn, usually approximately 30-120 micrometers.

According to the present invention, the coating can be carried out as a single coating or as a double coating, in which case the coating pastes can be used as single coating pastes and as so called pre-coating and surface-coating pastes. Triple (or even multiple, 4-10 fold) coatings are possible, too. In general, the coating mixture according to the present invention comprises 10-100 parts by weight of at least one pigment or a mixture of pigments, 0.1-30 parts by weight of at least one binder, and 1-10 parts by weight of other additives which are known per se.

The typical composition of a pre-coating mixture is as follows:

| | | |
|---|---|---|
| Coating pigment | 100 | parts by weight |
| (for example, coarse | | |
| calcium carbonate) | | |
| Binder | 1-20 | weight-% of the pigment |
| Additives and auxiliary agents | 0.1-10 | weight-% of the pigment |

| | |
|---|---|
| Water | balance |

Water is added to the pre-coating mixture so that the solids content is generally 40-70%. According to the present invention, the composition of the surface-coating mixture or single coating mixture is for example as follows:

| | | |
|---|---|---|
| Coating pigment I | 10-90 | parts by weight |
| (for example fine carbonate) | | |
| Coating pigment II | 10-90 | parts by weight |
| (for example fine kaolin) | | |
| Pigment total | 100 | parts by weight |
| Binder | 1-20 | parts by weight |
| Additives and auxiliary agents | 0.1-10 | parts by weight |

| | |
|---|---|
| Water | balance |

Water is added to such a coating mixture so that the dry solids content is typically from 50 to 75%.

According to the present invention, in the coating mixtures presented above it is possible to use pigments that have a steep particle size distribution, which means that a maximum of 35% of the pigment particles are smaller than 0.5 μm, preferably at maximum 15% are smaller than 0.2 μm.

The present invention can be used with any pigment. Examples of such pigments are precipitated calcium carbonate, ground calcium carbonate, calcium sulphate, calcium oxalate, aluminium silicate, kaolin (hydrous aluminium silicate), aluminium hydroxide, magnesium silicate, talc (hydrous magnesium silicate), titanium dioxide and barium sulphate, and mixtures of them. It is possible to use synthetic pigments, too. Of the pigments mentioned above, the main pigments are kaolin, calcium carbonate, precipitated calcium carbonate and gypsum, which in general constitute over 50% of the dry solids in the coating mix. Calcined kaolin, titanium dioxide, satin white, aluminium hydroxide, sodium silicoaluminate and plastics pigments are additional pigments, and in general the amounts used are less than 25% of the dry solids in the mix. Of the special pigments, special-quality kaolins and calcium carbonates, as well as barium sulphate and zinc oxide, should be mentioned.

More preferably, the present invention is used with calcium carbonate, calcium sulphate, aluminium silicate and aluminium hydroxide, magnesium silicate, titanium dioxide and/or barium sulphate, as well as mixtures thereof, in which case a more preferable main pigment in the pre-coating mixtures is calcium carbonate or gypsum and in the surface-coating mixtures of calcium carbonate or gypsum and kaolin.

As binders in the coating mixture it is possible to use any known binders generally employed in paper production. Besides individual binders, it is also possible to use mixtures of binders. Examples of typical binders include synthetic latexes made of polymers or copolymers of ethylenically unsaturated compounds, for instance copolymers of the butadiene styrene type, which possibly also have a comonomer containing a carboxyl group, such as acrylic acid, itaconic acid or maleic acid, and polyvinyl acetate having comonomers that contain carboxyl groups. Together with the materials cited above, it is also possible to use as binders, for example, the water-soluble polymers, starch, CMC, hydroxyethyl cellulose and polyvinyl alcohol.

Furthermore, it is possible to use conventional additives and auxiliary agents, such as dispersants (e.g. sodium salt of polyacrylic acid), agents affecting the viscosity and water retention of the mix (e.g. CMC, hydroxyethyl cellulose, polyacrylates, alginates, benzoate), lubricants, hardeners used for improving water-resistance, optical auxiliary agents, anti-foaming agents, pH control agents, and preservatives, in the coating composition. Examples of lubricants include sulphonated oils, esters, amines, calcium or ammonium stearates; an example of agents improving water resistance is glyoxal; examples of optical auxiliary agents are diaminostilbene disulphonic acid derivatives; examples of anti-foaming agents are phosphate esters, silicones, alcohols, ethers, vegetable oils; examples of pH control agents are sodium hydroxide and ammonia; and finally examples of preservatives are formaldehyde, phenol, quaternary ammonium salts.

The covering power of the coating provided by the curtain coating correlates with the smoothness of the print quality and the “quality” of the halftone dots. This means that when the covering power is of the order of curtain coating, there is almost no spottiness. Also, the better the coverage of the coating is, the smaller the spreading of dots/the amount of missing dots is.

By means of the present invention it is possible to produce coated and, optionally, calendered cellulose-bearing material webs, too, which have excellent printability properties, good smoothness and high opacity and brightness. Here, “cellulose-bearing material” means in general paper or cardboard or a corresponding material which contains cellulose and which is sourced from lignocellulose-bearing raw material, especially wood or one-year or perennial plants. The material in question can be wood-containing or wood-free and it can be produced from mechanical, chemi-mechanical or chemical pulp. The pulp and mechanical pulp can be bleached or unbleached. Recycled fibres, especially recycled paper or recycled cardboard can be included in the material, too.

An apparatus for manufacturing a coated paper product according to the present invention comprises
a paper machine apparatus for production of such base paper web, the porosity of which is at least 300 ml/min (Bentsen), in which case the production speed of the apparatus is at least 2000 m/min,
a coater which can be used for coating of the base paper web produced at the paper machine with pigment-bearing coating composition.

The coater comprises a curtain coater that can be used at a coating speed which is at least 2000 m/min and which, at the same time, is at least 2.1 times higher than the production speed of the paper machine apparatus.

According to the present invention, the apparatus can comprise two paper machines or more, the webbing speed of which are typically at maximum approximately 1000 m/min. These paper machines are preferably arranged in the same factory hall together with the coater. The coater can be arranged for instance in line with one paper machine so that the reels coming from this paper machine are directly transferable to the coater, for instance by rolling the reels, whereas from the other paper machine/machines the reels are transferred in axial direction from these paper machines. In the case of several paper machines, the coating speed of the curtain coater is chosen so that it is at least somewhat higher than the combined webbing speed of the paper machines. In order to avoid production breaks it is advantageous to choose a coating speed which is approximately 10%, especially at least 20%, in practice, however, at maximum approximately 100% higher than the production speed of the paper machine (machines).

As mentioned above, in cases where paper webs coming from one or more paper machines are coated with one coater, it is advantageous to equip the apparatus with conveyors, which are used to transfer paper reels from the paper machine to the coating station.

The following non-limiting examples describe the present invention more closely.

### EXAMPLES

Coating test runs were made at pilot scale and in production. The base papers needed were produced both in production and with the test machine.

Base Papers

A pilot apparatus was used to produce base paper, the raw materials of which were sulphate pulp and mechanical pulp. The objective was to produce typical LWC base paper, using a modern base paper production technique (gap former, shoe press).

The base paper was produced at two different speeds: 27 m/s (1620 m/min) and 32.5 m/s (1950 m/min). Table 1 shows the most important run values and base paper properties. As the table values show, increasing of the speed requires, with regard to the runability, a bigger difference in draw. This, in turn, clearly increases the porosity of the base paper (in this test more than 60%).

TABLE 1
Bases produced with the test machine.

| | base 1 | base 2 |
|---|---|---|
| speed [m/s] | 27 | 32.5 |
| difference in draw [%] | 1.1 | 2.1 |
| porosity [ml/min] | 243 | 397 |
| grammage [g/m²] | 31.8 | 32.3 |
| bulk [cm³/g] | 1.93 | 1.93 |

A test run of the base paper was carried out in the production, too. In this run grinding of masses, machine finishing and difference in draw of the press were changed in order to change the porosity level.

The test base papers are shown in Table 2. Base 3 represents a low porosity point, whereas base 4 represents a high porosity point. At these points the calendering has been lighter than normal. Base 5 is a normal machine finished production base paper, which explains its more compact structure.

TABLE 2
Production bases.

| | base 3 | base 4 | base 5 |
|---|---|---|---|
| porosity [ml/min] | 310 | 425 | 210 |
| grammage [g/m²] | 40.7 | 40.2 | 42.6 |
| bulk [cm³/g] | 1.65 | 1.61 | 1.46 |

Coating Tests

The base papers 4 and 5 were coated in the coating test runs at pilot scale.

A conventional paste formula with 60 parts of Hydrocarb 90 and 40 parts of Hydragloss 90, was used as the coating paste. The latexes and the other additives of the paste were well-known and well suitable for blade and film coating.

In the test runs both bases were coated both at a jet blade station and at a film sizer. In both cases two different coat weights were tested. In the coating the aim was to achieve as realistic conditions as possible: the coating speed was 2000 m/min, the temperature of the paste was 35° C., an infra-preheater was used to heat up the web before the coating stations to a target temperature of 40° C. In the test the aim was to use a maximum solids content, with regard to the speed and the control of the coat weight.

The coated samples were end calendered using an Option 8 multi-nip calender. The calendering speed was 1200 m/min, the linear load 200 kN/m and the temperatures of the thermo rolls 110/120° C. The coated and end calendered samples were printed to a standard density with a HSWO test printing machine from KCL.

The basic technical values of paper were determined from both unprinted and printed samples. In addition, the mottling values were determined from the printed samples with a Papeye apparatus, from C70 and B70% fields. Moreover, using an electron microscope, i.e. SEM, the covering power was determined from the unprinted samples. In the method, pictures were taken using the backscattering picture formation technique and from the pictures the covering power was determined with the picture analysis method. The covering power was calculated from ten parallel pictures.

TABLE 3
The results from the blade and film covering runs.

| | | OC-JET 7 | OC-JET 7 | OC-JET 10 | OC-JET 10 | OS 7 gsm | OS 7 gsm | OS 9 gsm | OS 9 gsm |
|---|---|---|---|---|---|---|---|---|---|
| | | gsm base | gsm base | gsm base | gsm base | base 5 | base 4 | base 5 | base 4 |
| | | 5 “compact” | 4 “porous” | 5 “compact” | 4 “porous” | “compact” | “porous” | “compact” | “porous” |
| Grammage | g/m² | 58.3 | 56.7 | 64.4 | 62.1 | 57.7 | 55.8 | 62.4 | 60.7 |
| Coat weight | g/m² | 15.8 | 16.2 | 21.9 | 21.6 | 14.2 | 15.3 | 18.9 | 20.2 |
| Gloss Tappi 75° | Ave | 52 | 49 | 62 | 56 | 47 | 41 | 55 | 51 |
| PPS 10 smoothness | | 1.43 | 1.63 | 1.18 | 1.39 | 2.08 | 2.31 | 1.92 | 2.08 |
| Covering power | % | 86.1 | 84.2 | 96.1 | 90.6 | 83.6 | 81.3 | 91.9 | 89.3 |
| Printed gloss | % | 68 | 65 | 75 | 71 | 60 | 58 | 65 | 62 |
| Printed PPS10 smoothness | μm | 1.80 | 2.06 | 1.55 | 1.78 | 2.48 | 2.66 | 2.34 | 2.56 |
| Papeye mottling | B70% | 6.42 | 6.66 | 6.36 | 6.70 | 7.31 | 7.70 | 6.89 | 7.34 |
| Papeye mottling | C70% | 4.63 | 4.71 | 4.53 | 4.90 | 4.61 | 4.76 | 4.47 | 4.78 |
| Print through | | 0.083 | 0.084 | 0.071 | 0.074 | 0.087 | 0.091 | 0.079 | 0.081 |

Blade coated samples with a coat weight of 7 g/m²:
gloss of a porous sample approximately 2 units lower
surface of a porous sample approximately 0.2 μm coarser
same differences can be observed in printed gloss and smoothness, too
both B70 and C70 mottling of a porous sample are 0.2-0.3 units higher
covering power of a porous sample is approximately 2 units lower
print through capacity of a porous sample is higher.

The differences are similar but bigger for blade coated samples with a coat weight of 10 g/m².

Film coated samples with a coat weight of 7 g/m²:
gloss of a porous sample is approximately 6 units lower, but the difference in printed gloss is only approximately 2 units
surface of a porous sample is approximately. 0.3 μm coarser both in the unprinted and printed surface
both B70 and C70 mottling of a porous sample is 0.2-0.4 units higher
covering power of porous sample is approximately 2 units lower
print through capacity of a porous sample is higher.

The differences are similar and almost equally big for film coated samples with a coat weight of 9 g/m².

The curtain coating tests were carried out with a test apparatus. In the test run the bases 1 and 2, which were prepared at the pilot plant, as well as the production bases 3 and 4 were coated. The pigments Hydrocarb 60, Capim SP and Hydragloss 90 were used in the test runs. The coat weights were 13 g/m² on each side. The coating speed was 1200 m/min. The samples were end calendered with an Optiload 8 multi-nip calender. The calendering speed was 830 m/min, the linear load 200 kN/m and the temperatures of the thermo reels 145° C. The samples were printed with a HSWO test printing machine to standard density.

TABLE 4
The results from the curtain coating test run.

| | | Curtain 13 | Curtain 13 | Curtain 13 | Curtain 13 |
|---|---|---|---|---|---|
| | | gsm base | gsm base | gsm base | gsm base |
| | | 3 “compact” | 4 “porous” | 1 “compact” | 2 “porous” |
| Grammage | g/m² | 65.1 | 65.8 | 56.9 | 57.7 |
| Coat weight | g/m² | 24.9 | 25.1 | 24.4 | 25.4 |
| Gloss Tappi 75° | Ave | 66 | 67 | 64 | 63 |
| PPS 10 smoothness | | 1.38 | 1.33 | 1.45 | 1.55 |
| Covering power | % | 98.2 | 98.3 | 97.0 | 97.2 |
| Printed gloss | % | 77 | 80 | 77 | 75 |
| Printed PPS10 smoothness | μm | 1.73 | 1.65 | 1.53 | 1.61 |
| Papeye mottling | B70% | 5.87 | 5.83 | 5.87 | 5.88 |
| Papeye mottling | C70% | 4.19 | 4.14 | 4.44 | 4.39 |
| Print through | | 0.056 | 0.055 | 0.122 | 0.115 |

As the laboratory results in Table 4 show, there are hardly any differences in the different gloss and smoothness values (both unprinted and printed) within the measuring accuracy limits. Especially significant is that the porosity of the base paper does not affect the covering power at all. The effect of the porosity of the base paper on the mottling is non-existent, too, within the measuring accuracy. The print through capacity, too, has remained at the same level regardless of the base.

1: Coated paper product comprising
a base paper, the porosity of which is at least 300 ml/min (Bentsen) and at least one side of which is coated with a pigment-bearing coating layer,
characterized in that
the coating layer comprises a homogeneous film, which is formed of binder and pigments and which is brought onto the surface of the base paper using curtain coating so that the variation of the grammage of the layer is less than 5% and so that the coating layer is not penetrated into the base paper, and
the coating layer covers at least 95% of the surface of the base paper.

2: The paper product according to claim 1, characterized in that the grammage of the coating layer is at maximum 17 g/m²/paper side, preferably approximately 6-15 g/m²/paper side.

3: The paper product according to claim 1, characterized in that the grammage of the base paper is less than 90 g/m².

4: The paper product according to claim 1, characterized in that the porosity of the paper is at least 310 ml/min.

5: Method for producing a coated paper product, according to which method
using a paper machine, a base paper web is formed, the porosity of which is at least 300 ml/min (Bentsen), and
the base paper web is coated at least on one side with a pigment-bearing coating composition,
characterized in that
the paper web is coated using curtain coating and a coating speed of at least 2000 m/min.

6: The method according to claim 5, characterized in that a paper web is coated with a coating layer which comprises a homogeneous film which is formed of binder and pigment and which is brought onto the surface of the base paper so that the variation of the grammage of the layer is less than 5%, and so
that the coating layer is not substantially penetrated into the base paper and
that the coating layer covers at least 95% of the surface of the base paper.

7: The method according to claim 5, characterized in that on the surface of the paper web a coating composition is applied, the dynamic surface tension of which is approximately 20-60 mN/m, especially approximately 35-55 mN/m, preferably less than approximately 40 mN/m.

8: The method according to claim 5, characterized in that on the surface of the paper web a coating composition is applied using a minimum volumetric flow rate/width, which is over 1.0 cm²/s, especially at least 1.5 cm²/s, in order to produce a stable coating curtain.

9: The method according to claim 5, characterized in that a gap which is approximately 1-1000 mm, most suitably approximately 1-500 mm, especially approximately 10-500 mm, is left between the nozzle of the curtain coater and the paper web.

10: The method according to claim 5, characterized in that the thickness of the film which is brought to the paper web is approximately 0.1-10 mm, especially approximately 1-5 mm.

11: The method according to claim 5, characterized in that on the surface of the paper web a coating layer is formed, the grammage of which is at maximum 15 g/m²/paper side.

12: The method according to claim 5, characterized in that the paper web is coated using a coating speed which is higher than 2100 m/min, preferably higher than 2500 m/min.

13: Apparatus for production of a coated paper product, which apparatus comprises
a paper machine apparatus for production of such a base paper web, the porosity of which is at least 200 ml/min (Bentsen), and
a coater which can be used to coat the base paper web produced at the paper machine, with a pigment-bearing coating composition,
characterized in that
the production speed of the paper machine apparatus is at least 2000 m/min, and
the coater comprises a curtain coater, which can be used at a coating speed which is at least 10% higher than the said production speed.

14: The apparatus according to claim 13, characterized in that the paper machine apparatus can be used to produce base paper webs, the porosity of which are at least 300 ml/min (Bentsen).

15: The apparatus according to claim 13, characterized in that
the apparatus comprises at least two paper machines per one coater,
the coater comprises a curtain coater, and
the curtain coater can be used at a coating speed which is at least 2000 m/min and which, at the same time, is at least 10% higher than the combined webbing speeds of the paper machines.
